(19) United States
(12) Patent Application Publication
(10) Pub. No.: US 2021/0240116 A1
(43) Pub. Date: Aug. 5, 2021

(54) CONDITIONERS

(71) Applicant: Hewlett-Packard Development Company, L.P., Spring, TX (US)

(72) Inventors: Duane A Koehler, Vancouver, WA (US); Robert Yraceburu, Vancouver, WA (US); Richard Lee Brinkly, Vacncouver, WA (US)

(21) Appl. No.: 17/049,121

(22) PCT Filed: Jun. 11, 2018
(86) PCT No.: PCT/US2018/036867

§ 371 Date: Oct. 20, 2020

(51) Int. Cl. G03G 15/20

(52) U.S. Cl. CPC G03G 15/2039

(57) ABSTRACT

A conditioner includes a pressure roller assembly, a heating element, a drive motor, a current sensor, a plurality of print media sensors, and a controller. The heating element heats the pressure roller assembly. The drive motor rotates the pressure roller assembly. The current sensor senses a current of the heating element. The plurality of print media sensors sense the movement of print media through the conditioner. The controller is to turn off the heating element in response to any one of detecting an anomaly in the sensed movement of the print media or detecting a sensed current outside a predetermined range.

### BACKGROUND

Inkjet printers can deposit quantities of printing fluid onto a printable media (e.g., paper, plastic, etc.). In some examples, inkjet printers can create a curl and/or cockle in the printed media when the printing fluid droplets deposited by the inkjet printer are not completely dry. In some examples, a number of physical properties of the printable media can be changed when the printing fluid droplets deposited by the inkjet printer are not completely dry. For example, the stiffness of the printable media can be changed when the printing fluid droplets deposited by the inkjet printer are not completely dry. The curl, cockle, and/or other physical properties that change due to the printing fluid droplets can make finishing processes difficult.

### BRIEF DESCRIPTION OF THE DRAWINGS

FIG. 1 is a schematic diagram illustrating one example of a conditioner.

FIG. 2 is a block diagram illustrating another example of a conditioner.

FIG. 3 is a block diagram illustrating another example of a conditioner.

FIG. 4 is a block diagram illustrating one example of a controller.

FIG. 5 is a schematic diagram illustrating one example of a conditioner including system sensors.

FIG. 6 is a schematic diagram illustrating one example of a conditioner including hardware interlocks.

FIGS. 7A-7C are flow diagrams illustrating one example of a method for operating a printer.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

A number of systems and devices for a partially dried inkjet media conditioner are described herein. In some examples, a partially dried inkjet media conditioner includes a heated pressure roller assembly to apply pressure to a first side of partially dried inkjet media and apply heat to a second side of the partially dried inkjet media. As used herein, partially dried inkjet media may include media with applied printing fluid from an inkjet type printing device that is not completely dried on the media. The conditioner may be utilized to increase evaporation of printing fluid applied to the partially dried inkjet media and remove or reduce distorted properties from the partially dried inkjet media.

The partially dried inkjet media may provide difficulties when stacking, aligning, and/or finishing. For example, the partially dried inkjet media may have distorted properties such as a curl, a cockle, a reduction in stiffness, increased surface roughness, extruding fibers from the surface, misaligned fibers, and/or increased sheet to sheet friction of the media. In some examples, these distorted properties may be caused by printing fluid deposited on the media and the media absorbing the printing fluid. For example, the printing fluid may be in a liquid state that may be absorbed by a media such as paper. In this example, the liquid state of the printing fluid may cause the distorted properties of the media in a similar way that other liquids may distort the properties of the media.

In some examples, the conditioner may be utilized to increase evaporation of printing fluid applied to the partially dried inkjet media. In some examples, the conditioner can remove or reduce the distorted properties generated by the printing fluid applied to the partially dried inkjet media. For example, the partially dried inkjet media may include extruding fibers from the surface that can be embedded into the surface of the partially dried inkjet media by the pressure and heat applied by the conditioner.

The conditioner may utilize high power heaters to assist with ink vehicle evaporation and conditioning of the partially dried inkjet media. This heating and conditioning may be used to make the media output from the conditioner compatible with a finishing device, such as a stapler, hole punch, collator, stacker, etc. The high power heaters should be carefully controlled to prevent them from overheating. If overheating occurs, the result may be poor stack quality, media jams, damage to the printer, or even a customer safety risk. The high power heaters may use halogen lamp heating sources that are difficult to control, since their resistance is not constant, but rather a strong function of temperature. When the halogen bulb is cold, the peak currents may be very high. Therefore, it is difficult to distinguish between a faulty system and some corner case events with a correctly functioning system.

Accordingly, disclosed herein is a conditioner including a heated pressure roller assembly that may be arranged between a printing device and a finisher in an inkjet printer. The conditioner is shut down in response to any one of a temperature sensor being outside an expected range, media sensors detecting an anomaly in the movement of print media through the printer, a sensed drive motor current being outside an expected range, a sensed current through an AC inlet providing AC power to the printer not being within an expected range, watchdog timers controlling various aspects of the printer elapsing, a thermal or overcurrent fuse tripping, or a door sensor detecting an open door of the printer. This failsafe system for the conditioner utilizes a multi-level protection scheme to protect the customer, prevent hardware damage, and provide system diagnostics.

FIG. 1 is a schematic diagram illustrating one example of a conditioner 100. Conditioner 100 may include a dryer 102, a print media path 104, a pressure roller assembly 106, a heating element 120, print media sensors 124₁ and 124₂, and temperature sensors 126₁ and 126₂. Pressure roller assembly 106 may include a pressure roller 108, a belt 110, and a platen 112. Partially dried inkjet media may enter dryer 102 after exiting a printing device (not shown). Dryer 102 may include heating elements for drying partially dried inkjet media output from the printing device. From dryer 102 the partially dried inkjet media may enter pressure roller assembly 106.

Pressure is applied to the top surface of the media by pressure roller 108 as indicated by arrow 116. The bottom surface of the media contacts belt 110 over platen 112. Pressure roller 108 rotates in the direction indicated by arrow 114 and belt 110 rotates in the direction indicated by arrow 118 to draw print media between pressure roller 108 and belt 110. Heating element 120 may apply heat to pressure roller assembly 106 as indicated at 122. In one example as shown in FIG. 1, heating element 120 may apply heat to belt 110, and belt 110 may apply the heat to the print media.

The temperature of pressure roller assembly 106 may be sensed by temperatures sensors 126₁ and 126₂. In one example, temperature sensors 126₁ and 126₂ may sense the temperature of heating element 120, belt 110, or pressure roller 108 at different locations, such as near the center and side of the pressure roller assembly 106. While two temperature sensors 126₁ and 126₂ are illustrated in FIG. 1, in other examples, any suitable number of temperature sensors may be used to sense temperatures of pressure roller assembly 106 and/or dryer 102.

Print media sensors 124₁ and 124₂ may sense the movement of print media at various locations along print media path 104 to detect anomalies in the sensed movement, such as a paper jam. In one example, print media sensors 124₁ and 124₂ are optical sensors. While two print media sensors 124₁ and 124₂ are illustrated in FIG. 1, in other examples, any suitable number of print media sensors may be used to sense the movement of print media at various locations along print media path 104.

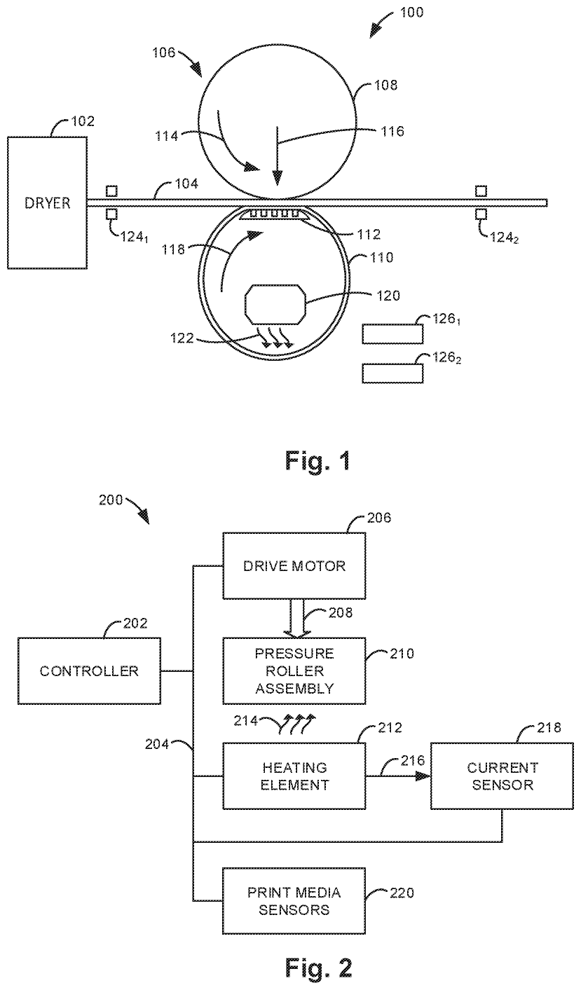

FIG. 2 is a block diagram illustrating another example of a conditioner 200. Conditioner 200 includes a controller 202, a drive motor 206, a pressure roller assembly 210, a heating element 212, a current sensor 218, and a plurality of print media sensors 220. Controller 202 is electrically coupled to drive motor 206, heating element 212, current sensor 218, and print media sensors 220 through a communication path 204. Drive motor 206 is mechanically coupled to pressure roller assembly 210 as indicated at 208 to rotate the pressure roller assembly. In one example, drive motor 206 rotates pressure roller 108 and/or belt 110 previously described and illustrated with reference to FIG. 1. Current sensor 218 senses the current of heating element 212 as indicated at 216. Heating element 212 heats pressure roller assembly 210 as indicated at 214. In one example, heating element 212 is similar to heating element 120 and heats belt 110 as previously described and illustrated with reference to FIG. 1.

Print media sensors 220 sense the movement of print media through the conditioner. In one example, print media sensors 220 are similar to print media sensors 124₁ and 124₂ and sense the movement along print media path 104 as previously described and illustrated with reference to FIG. 1. Controller 202 turns off heating element 212 in response to any one of detecting an anomaly in the sensed movement of the print media or detecting a sensed current outside a predetermined range. In one example, controller 202 detects anomalies in the sensed movement of the print media within two seconds of an anomaly and turns off heating element 212.

Conditioner 200 may also include a plurality of temperature sensors (not shown), such as temperatures sensors 126₁ and 126₂ of FIG. 1. In this example, each temperature sensor senses a temperature of heating element 212. Controller 202 turns off heating element 212 in response to any one of detecting a sensed temperature outside a predetermined range based on an operating state of each of heating element 212 and the drive motor 206 or detecting an anomaly between the plurality of temperature sensors.

Controller 202 may include a plurality of application specific integrated circuits (ASICs) and each ASIC may include a watchdog timer. In this example, controller 202 turns off heating element 212 and drive motor 206 in response to any one of the watchdog timers elapsing. Conditioner 200 may also include a plurality of door sensors (not shown) providing access to the pressure roller assembly 210, heating element 212, and drive motor 206. In this example, controller 202 turns off heating element 212 and drive motor 206 in response to detecting an open door.

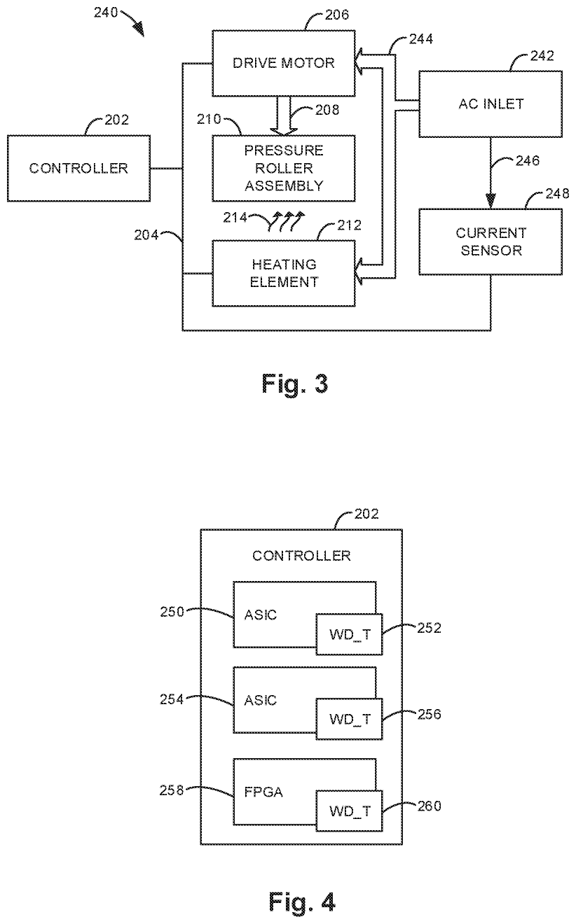

FIG. 3 is a block diagram illustrating another example of a conditioner 240. Conditioner 240 includes a controller 202, a drive motor 206, a pressure roller assembly 210, a heating element 212, an AC inlet 242, and a current sensor 248. Controller 202 is electrically coupled to drive motor 206, heating element 212, and current sensor 248 through a communication path 204. Drive motor 206 is mechanically coupled to pressure roller assembly 210 as indicated at 208 to rotate the pressure roller assembly. In one example, drive motor 206 rotates pressure roller 108 and/or belt 110 previously described and illustrated with reference to FIG. 1. AC inlet 242 receives AC power and supplies the AC power to drive motor 206 and heating element 212 through an AC power path 244. Current sensor 248 senses the current through AC inlet 242 as indicated at 246. Heating element 212 heats pressure roller assembly 210 as indicated at 214. In one example, heating element 212 is similar to heating element 120 and heats belt 110 as previously described and illustrated with reference to FIG. 1.

Controller 202 turns off heating element 212 in response to detecting a sensed current outside a predetermined range based on an operating state of each of the heating element 212 and the drive motor 206. Conditioner 240 may also include a plurality of temperature sensors (not shown), such as temperatures sensors 126₁ and 126₂ of FIG. 1. In this example, each temperature sensor senses a temperature of heating element 212. Controller 202 turns off heating element 212 in response to any one of detecting a sensed temperature outside a predetermined range based on an operating state of each of the heating element 212 and the drive motor 206 or detecting an anomaly between the plurality of temperature sensors. Conditioner 240 may also include a plurality of door sensors (not shown) providing access to the pressure roller assembly 210, heating element 212, and drive motor 206. In this example, controller 202 turns off heating element 212 and drive motor 206 in response to detecting an open door.

FIG. 4 is a block diagram illustrating one example of a controller 202. Controller 202 may include a first ASIC 250, a second ASIC 254, and a field programmable gate array (FPGA) 258. First ASIC 250 includes a watchdog timer 252. Second ASIC 254 includes a watchdog timer 256. FPGA 258 includes a watchdog timer 260. In one example, first ASIC 250 may monitor a plurality of door sensors, second ASIC 254 may monitor a plurality of temperature sensors of the conditioner and the dryer, and FPGA 258 may drive heating elements of the conditioner. The conditioner and the dryer may be turned off in response to any one of the first watchdog timer 252, the second watchdog timer 256, or the third watchdog timer 260 elapsing. In other examples, each ASIC 250 and 254 and FPGA 258 may be used to provide independent monitoring of all system sensors, or a large subset of all system sensors, so that the multiple ASICs and/or FPGAs provide redundant monitoring to each other.

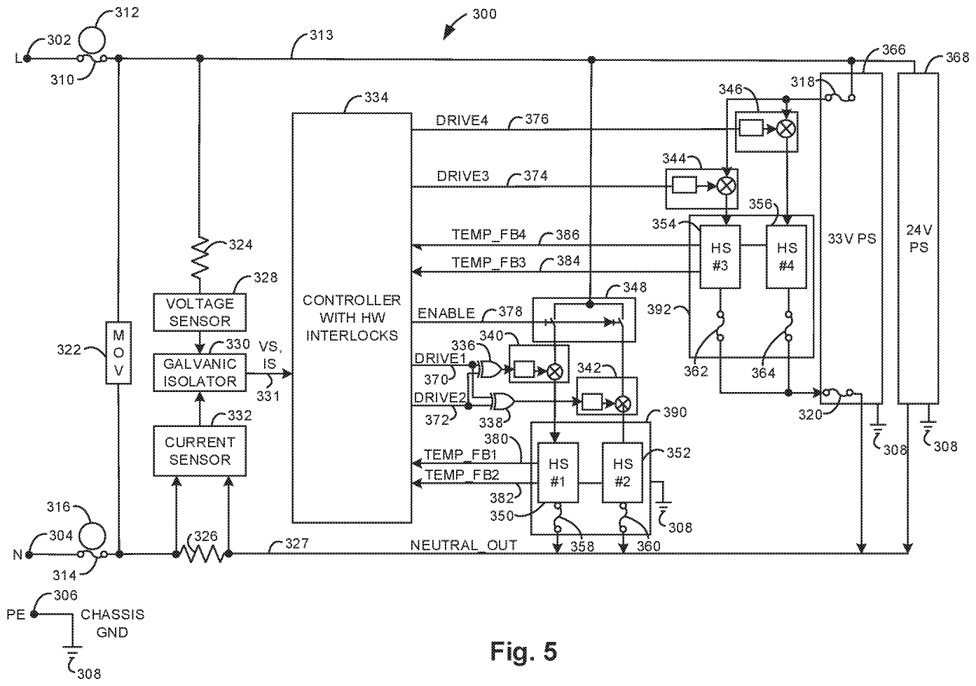

FIG. 5 is a schematic diagram illustrating one example of a conditioner 300 including system sensors. Conditioner 300 may include an overcurrent fuse 310 with a blown fuse light emitting diode (LED) 312; an overcurrent fuse 314 with a blown fuse LED 316; overcurrent fuses 318 and 320; a metal oxide varistor (MOV) 322; resistors 324 and 326; a voltage sensor 328; a galvanic isolator 330; a current sensor 332; a controller 334 with hardware interlocks; XOR gates 336 and 338; triacs 340, 342, 344, and 346; a relay 348; heat sources 350, 352, 354, and 356; thermal fuses 358, 360, 362, and 364; and power supplies 366 and 368. First heat source 350 and second heat source 352 may be used to heat a pressure roller assembly 390. Third heat source 354 and fourth heat source 356 may be part of a dryer 392.

An AC line (L) node 302 is electrically coupled to one side of fuse 310. Blown fuse LED 312 indicates if fuse 310 is blown. The other side of fuse 310 is electrically coupled to one side of MOV 322, one side of resistor 324, the AC line input of relay 348, the AC line input of power supply 366, the AC line input of power supply 368, and one side of fuse 318 through an AC line signal path 313. An AC neutral (N) node 304 is electrically coupled to one side of fuse 314. Blown fuse LED 316 indicates if fuse 314 is blown. The other side of fuse 314 is electrically coupled to the other side of MOV 322, one side of resistor 326, and an input to current sensor 332. A protective earth (PE) node 306 is electrically coupled to a chassis ground 308.

The other side of resistor 324 is electrically coupled to the input of voltage sensor 328. The output of voltage sensor 328 is electrically coupled to a voltage sensor signal input of galvanic isolator 330. The other side of resistor 326 is electrically coupled to an input of current sensor 332 through a neutral out signal path 327. The output of current sensor 332 is electrically coupled to a current sensor signal input of galvanic isolator 330. The output of galvanic isolator 330 is electrically coupled to controller 334 through a voltage sense (VS) and current sense (IS) signal path 331.

A first drive output of controller 334 is electrically coupled to an input of XOR gate 336 and an input of XOR gate 338 through a DRIVE1 signal path 370. A second drive output of controller 334 is electrically coupled to an input of XOR gate 336 and an input of XOR gate 338 through a DRIVE2 signal path 372. The output of XOR gate 336 is electrically coupled to the control input of triac 340. The output of XOR gate 338 is electrically coupled to the control input of triac 342. A third drive output of controller 334 is electrically coupled to the control input of triac 344 through a DRIVE3 signal path 374. A fourth drive output of controller 334 is electrically coupled to the control input of triac 346 through a DRIVE4 signal path 376. An enable output of controller 334 is electrically coupled to the control input of relay 348 through an enable signal path 378.

A first temperature input of controller 334 is electrically coupled to a temperature sensor output of first heat source 350 through a first heat source temperature feedback (TEMP_FB1) signal path 380. A second temperature input of controller 334 is electrically coupled to a temperature sensor output of second heat source 352 through a second heat source temperature feedback (TEMP_FB2) signal path 382. A third temperature input of controller 334 is electrically coupled to a temperature sensor output of third heat source 354 through a third heat source temperature feedback (TEMP_FB3) signal path 384. A fourth temperature input of controller 334 is electrically coupled to a temperature sensor output of fourth heat source 356 through a fourth heat source temperature feedback (TEMP_FB4) signal path 386.

A first output of relay 348 is electrically coupled to the AC input of triac 340, and a second output of relay 348 is electrically coupled to the AC input of triac 342. The AC output of triac 340 is electrically coupled to the AC input of first heat source 350, and the AC output of triac 342 is electrically coupled to the AC input of second heat source 352. The neutral of first heat source 350 is electrically coupled to one side of thermal fuse 358, and the neutral of second heat source 352 is electrically coupled to one side of thermal fuse 360. The other side of thermal fuse 358 and the other side of thermal fuse 360 are electrically coupled to the neutral out signal path 327. Therefore, first heat source 350 (i.e., a heating element) is coupled in series with thermal fuse 358, and second heat source 352 (i.e., a heating element) is coupled in series with thermal fuse 360.

The other side of overcurrent fuse 318 is electrically coupled to the AC input of triac 344 and the AC input of triac 346. The AC output of triac 344 is electrically coupled to the AC input of third heat source 354, and the AC output of triac 346 is electrically coupled to the AC input of fourth heat source 356. The neutral of third heat source 354 is electrically coupled to one side of thermal fuse 362, and the neutral of fourth heat source 356 is electrically coupled to one side of thermal fuse 364. The other side of thermal fuse 362 and the other side of thermal fuse 364 are electrically coupled to one side of overcurrent fuse 320. The other side of overcurrent fuse 320 is electrically coupled to neutral out signal path 327.

AC line node 302 and AC neutral node 304 provide an AC inlet, such as AC inlet 242 of FIG. 3. Overcurrent fuses 310 and 318 protect conditioner 300 from an overcurrent on the AC line signal path 313. Overcurrent fuses 310 and 318 trip in response to a respective current through the fuses (e.g., due to a current to a heating element) exceeding a predetermined current. Overcurrent fuses 314 and 320 protect conditioner 300 from an overcurrent on the neutral out signal path 327. Overcurrent fuses 314 and 320 trip in response to a respective current through the fuses (e.g., due to a current from a heating element) exceeding a predetermined current. Power supply 366 may be a 33 volt DC power supply, and power supply 368 may be a 24 volt DC power supply. Power supplies 366 and 368 power the various DC components (e.g., controller 334, sensors, logic circuits, etc.) of conditioner 300.

MOV 322 protects conditioner 300 in the event of an overvoltage (e.g., lightning strike) by absorbing the overvoltage. Voltage sensor 328 senses the voltage on the AC line signal path 313 by sensing the voltage across resistor 324 to provide a sensed voltage signal. Current sensor 332 senses the current draw of conditioner 300 by sensing the current through resistor 326 to provide a sensed current signal. In one example, current sensor 332 is similar to current sensor 248 of FIG. 3. Galvanic isolator 330 receives the sensed voltage signal from voltage sensor 328 and the sensed current signal from current sensor 332. Galvanic isolator 330 electrically isolates the high voltage AC components of voltage sensor 328 and current sensor 332 from the low voltage DC components of controller 334. For example, galvanic isolator 330 may include an optocoupler to pass the sensed voltage signal and the sensed current signal to controller 334.

Controller 334 monitors the sensed voltage signal and the sensed current signal to ensure the signals remain within predefined parameters based on the operating state of the components of conditioner 300, including for example, heat sources 350, 352, 354, and 356. Controller 334 controls relay 348 via the enable signal on enable signal path 378. Relay 348 may be enabled to connect AC line signal path 313 to the AC inputs of triacs 340 and 342. Relay 348 may be disabled to disconnect AC line signal path 313 from the AC inputs of triacs 340 and 342. Controller 334 may enable relay 348 in response to not detecting any faults and disable relay 348 in response to detecting a fault.

Controller 334 provides drive signals to enable first heat source 350 via XOR gate 336 and triac 340, second heat source 352 via XOR gate 338 and triac 342, third heat source 354 via triac 344, and fourth heat source 356 via triac 346. Each triac 340, 342, 344, and 346 may include an optocoupler to galvanically isolate the low voltage DC drive signals output from controller 334 from the high voltage AC power being passed via the triacs to the AC inputs of the heat sources. XOR gates 336 and 338 ensure that one of the first heat source 350 or the second heat source 352 is active at a time. In other examples, XOR gates 336 and 338 may be excluded such that both first heat source 350 and second heat source 352 may be active at the same time.

Controller 334 monitors the sensed temperatures of heat sources 350, 352, 354, and 356 through temperature feedback signal paths 380, 382, 384, and 386, respectively. Controller 334 monitors the temperature feedback signals to ensure they remain within expected ranges based on the current operating state of each heat source. In response to controller 334 detecting an anomaly in the temperature feedback signals, controller 334 may turn off heat sources 350, 352, 354, and 356.

Thermal fuses 358, 360, 362, and 364 trip in response to the respective first heat source 350, second heat source 352, third heat source 354, and fourth heat source 356 exceeding a predetermined temperature to immediately turn off the respective heat source. In one example, thermal fuses 358, 360, 362, and 364 are resettable thermal fuses.

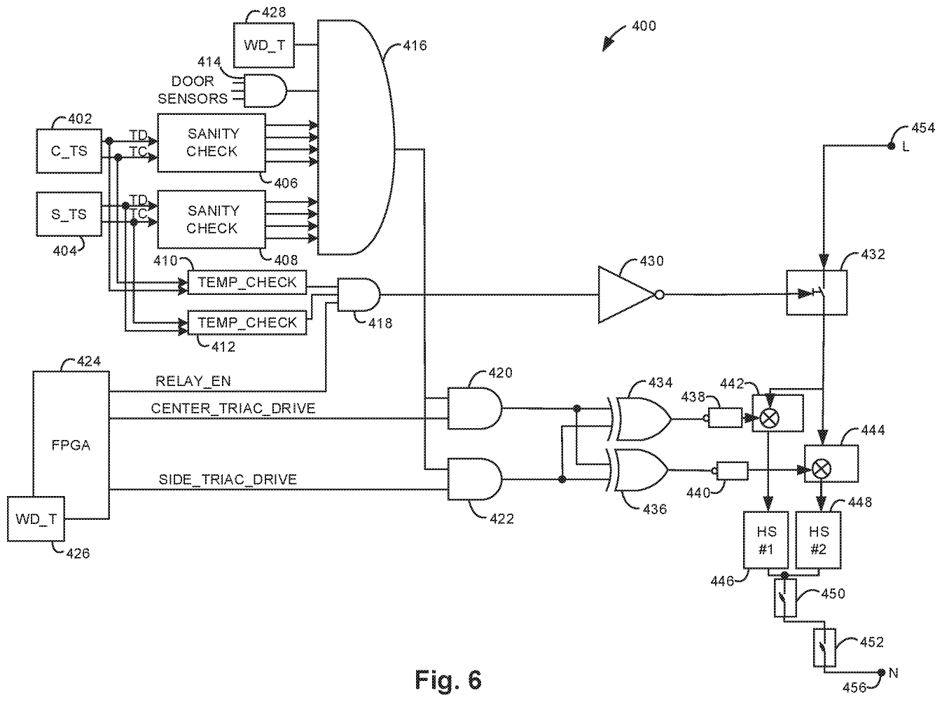

FIG. 6 is a schematic diagram illustrating one example of a conditioner 400 including hardware interlocks. Conditioner 400 includes temperature sensors 402 and 404; sanity check circuits 406 and 408; temperature check circuits 410 and 412; AND gates 414, 416, 418, 420, and 422; a field programmable gate array (FPGA) 424 including a watchdog timer (WD_T) 426; a watchdog timer 428; an inverter 430; a relay 432; XOR gates 434 and 436; opto triacs 438 and 440; triacs 442 and 444; heat sources 446 and 448; and thermal fuses 450 and 452.

The outputs of center temperature sensor (C_TS) 402 are electrically coupled to the inputs of sanity check circuit 406 and the inputs of temperature check circuit 410 through TD (reference signal) and TC (temperature signal) signal paths. The outputs of side temperature sensor (S_TS) 404 are electrically coupled to the inputs of sanity check circuit 408 and the inputs of temperature check circuit 412 through TD and TC signal paths. The outputs of sanity check circuits 406 and 408 are electrically coupled to inputs of AND gate 416. Each input of AND gate 414 is electrically coupled to a door sensor, and the output of AND gate 414 is electrically coupled to an input of AND gate 416. The output of watchdog timer 428 is electrically coupled to an input of AND gate 416. The output of AND gate 416 is electrically coupled to an input of AND gate 420 and an input of AND gate 422.

The output of temperature check circuits 410 and 412 and a relay enable (RELAY_EN) output of FPGA 424 are electrically coupled to inputs of AND gate 418. The output of AND gate 418 is electrically coupled to the input of inverter 430. The output of inverter 430 is electrically coupled to the control input of relay 432. A center triac drive output of FPGA 424 is electrically coupled to an input of AND gate 420. A side triac drive output of FPGA 424 is electrically coupled to an input of AND gate 422. The output of AND gate 420 is electrically coupled to an input of XOR gate 434 and an input of XOR gate 436. The output of AND gate 422 is electrically coupled to an input of XOR gate 436 and an input of XOR gate 434.

The output of XOR gate 434 is electrically coupled to the input of opto triac 438, and the output of XOR gate 436 is electrically coupled to the input of opto triac 440. The output of opto triac 438 is electrically coupled to the control input of triac 442, and the output of opto triac 440 is electrically coupled to the control input of triac 444.

AC line (L) node 454 is electrically coupled to the AC input of relay 432. The AC output of relay 432 is electrically coupled to the AC inputs if triacs 442 and 444. The AC output of triac 442 is electrically coupled to the AC input of first heat source 446. The AC output of triac 444 is electrically coupled to the AC input of second heat source 448. The neutrals of first heat source 446 and second heat source 448 are electrically coupled to one side of thermal fuse 450. The other side of thermal fuse 450 is electrically coupled to one side of thermal fuse 452. The other side of thermal fuse 452 is electrically coupled to the neutral (N) node 456.

First heat source 446 and second heat source 448 may be used to heat a pressure roller assembly. First heat source 446 may be used to heat a center portion of the pressure roller assembly, and second heat source 448 may be used to heat a side portion of the pressure roller assembly. Center temperature sensor 402 may sense the temperature of first heat source 446 toward the center of the pressure roller assembly, and side temperature sensor 404 may sense the temperature of second heat source 448 toward the side of the pressure roller assembly. Each of the center temperature sensor 402 and the side temperature sensor 404 may include a thermocouple and output a TD reference signal and a TC temperature signal.

Sanity check circuit 406 verifies that the TD and TC signals from center temperature sensor 402 are valid, and sanity check circuit 408 verifies that the TD and TC signals from side temperature sensor 404 are valid. Each sanity check circuit 406 and 408 may perform four verifications including verifying that TC<125° C., TC is not open or short, TD is not open or short, and (TD−TC)<210° C. In response to each successful verification, a logic high signal is output to AND gate 416. In response to each failed verification, a logic low signal is output to AND gate 416.

With each door sensor input to AND gate 414 indicating each door is closed, AND gate 414 outputs a logic high signal to AND gate 416. If a door sensor input indicates an open door, AND gate 414 outputs a logic low signal to AND gate 416. Watchdog timer 428 outputs a logic high signal to AND gate 416 unless the watchdog timer elapses. In one example, watchdog timer 428 may be a watchdog timer of an ASIC that provides the logic of conditioner 400 or a portion of the logic of conditioner 400. With the inputs to AND gate 416 indicating that the watchdog timer 428 has not elapsed, all doors are closed, and temperature sensors 402 and 404 are operating correctly, AND gate 416 outputs a logic high signal. In response to any one of the watchdog timer 428 elapsing, an open door, or a temperature sensor fault, AND gate 416 outputs a logic low signal.

Temperature check circuit 410 checks the TD and TC signals from center temperature sensor 402 to determine whether TD−TC<210° C. Temperature check circuit 412 checks the TD and TC signals from side temperature sensor 404 to determine whether TD−TC<210° C. With the relay enable signal from FPGA 424 logic high, and a logic high output signal from both temperature check circuits 410 and 412, AND gate 418 and inverter 430 enable first heat source 446 and second heat source 448 via relay 432. Relay 432 may be enabled to connect AC line node 454 to the AC inputs of triacs 442 and 444. Relay 432 may be disabled to disconnect AC line node 454 from the AC inputs of triacs 442 and 444.

With the output of AND gate 416 logic high, AND gate 420 outputs a logic high signal in response to a center triac drive signal from FPGA 424. With the output of AND gate 416 logic high, AND gate 422 outputs a logic high signal in response to a side triac drive signal from FPGA 424. XOR gates 434 and 436 ensure that one of the first heat source 446 or the second heat source 448 is active at a time. In other examples, XOR gates 434 and 436 may be excluded such that both first heat source 446 and second heat source 448 may be active at the same time.

Opto triac 438 galvanically isolates the center triac drive signal from the AC power of triac 442, and opto triac 440 galvanically isolates the side triac drive signal from the AC power of triac 444. In response to the center triac drive signal passing through AND gate 420 and XOR gate 434, triac 442 turns on first heat source 446 by connecting the AC line power to the AC input of first heat source 446. In response to the side triac drive signal passing through AND gate 422 and XOR gate 436, triac 444 turns on second heat source 448 by connecting the AC line power to the AC input of second heat source 448.

Thermal fuse 450 trips in response to first heat source 446 exceeding a predetermined temperature. Thermal fuse 452 trips in response to second heat source 448 exceeding a predetermined temperature. In one example, thermal fuses 450 and 452 are resettable thermal fuses. Since thermal fuse 450 is connected in series with thermal fuse 452, if either thermal fuse 450 or 452 trips, both first heat source 446 and second heat source 448 turn off immediately. Similar control logic (not shown) may be used to control heat sources of a dryer, such as third heat source 354 and fourth heat source 356 of dryer 392 of FIG. 5.

As illustrated in the previous figures, multiple layers of protection may be used to detect faults with the heat sources, e.g. heating element 120 of FIG. 1, heating element 212 of FIGS. 2 and 3, heat sources 350, 352, 354, and 356 of FIG. 5, or heat sources 446 and 448 of FIG. 6. In response to detecting a fault, the heat sources are turned off. In addition, the drive motor (e.g., drive motor 206 of FIGS. 2 and 3) may be turned off in response to detecting a fault.

Closed loop sanity tests may be performed using independent heat source drives, thermal sensors, and firmware. For example, if a thermal sensor feedback signal does not respond as expected to a drive signal amplitude, a fault may be generated. This is a flexible mechanism that may be tuned to adapt to various system conditions, such as page density, ambient temperature and humidity, printing speed, and AC voltage level. Filtering may be used to prevent false positives from triggering a fault. The system may also be tuned to tolerate intermittent conditions, and react differently if another system anomaly occurs, such as a paper jam, firmware assert, or unrelated hardware defect. Closed loop measurements permit the control system to observe the system and ensure that it behaves in a way that is consistent and expected, within a known tolerance band. The expected behavior may be captured during development using characterization testing under a variety of conditions.

Media sensors may be used to observe that the printed media is moving correctly through the conditioning system. This protects against the possibility of a paper jam creating a situation where flammable paper gets into close proximity to a heating source. The media may be tracked in real-time by a plurality (e.g., seven) independent optical sensors. This may allow a media transport anomaly to be detected with two seconds, well below the time needed to ignite paper with the heating sources in the system. In addition, a motor drive integrated circuit may include current sensing to detect if a motor current is out of range, and may disable the motor if it is stalled for more than one second or has excessive current.

Real-time current sensing may be used to measure how much power is actually being drawn from the AC inlet. This may detect cases where current is flowing where it shouldn't, or is different than expected. System characterization testing may be used to create expected profiles for various system operations, under a range of conditions (e.g., ambient temperature, AC input voltage, heating source temperature history, etc.).

Watchdog timers may be used to verify that the firmware is executing the safety algorithms that are described above. Note that safety algorithms may be distributed among three autonomous control points (two firmware, one hardware): the engine ASIC, a second ASIC that controls the conditioner sub-system, and an FPGA. The watchdog timers will detect if firmware is not running.

Circuit protection devices may be used as a final line of defense to prevent damage to the product or to protect the customers from safety hazards. In many cases, there are redundant fuses, so that a single-point fault cannot defeat these safety mechanisms. For instance, more than one fusing device may be used for the halogen lamp heat sources; one may be a resettable thermal device that trips when the pressure roller assembly temperature exceeds a maximum threshold, and one may be an overcurrent fuse that may open permanently if current exceeds a safe value for a predetermined period of time.

Redundant door sensors may be used to prevent customer access to any part of the product that might be dangerously hot, or might have dangerous voltages present. If a door is opened, the power may be immediately removed from the heating sources.

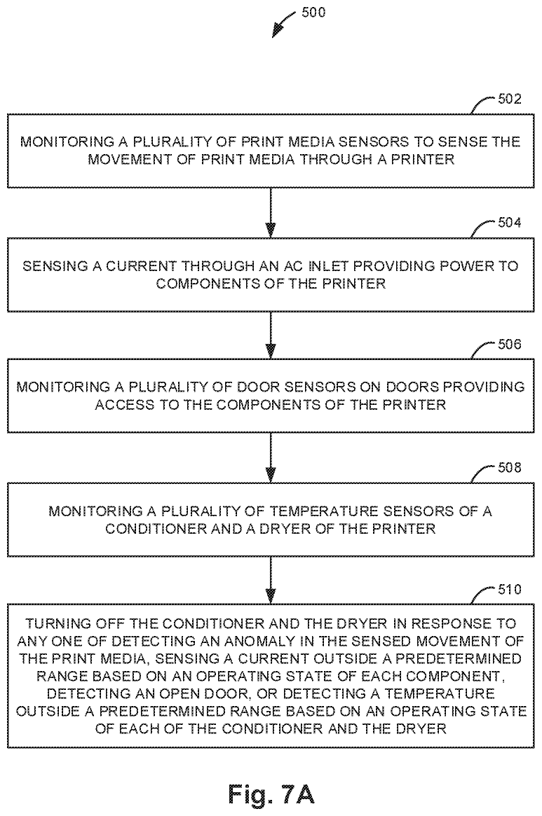

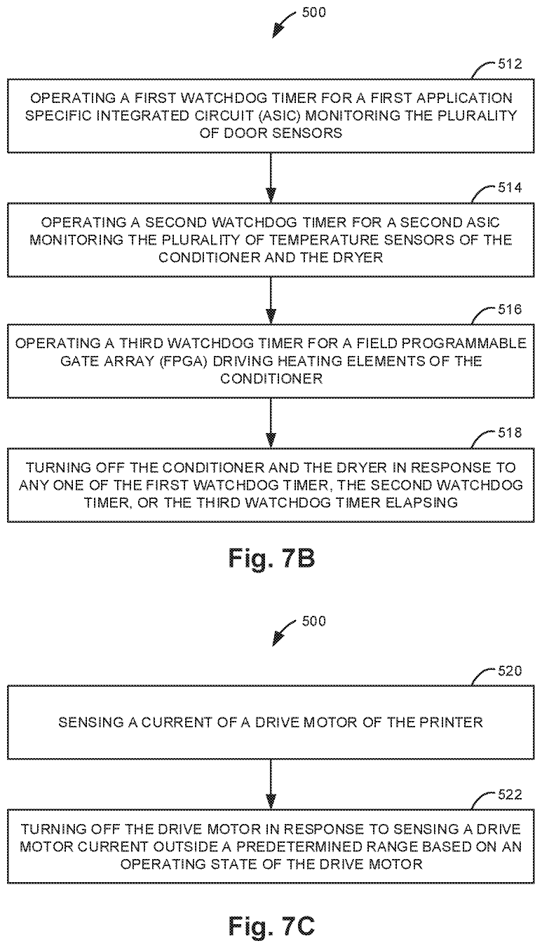

FIGS. 7A-7C are flow diagrams illustrating one example of a method 500 for operating a printer. As illustrated in FIG. 7A, at 502 method 500 includes monitoring a plurality of print media sensors to sense the movement of print media through a printer. At 504, method 500 includes sensing a current through an AC inlet providing power to components of the printer. At 506, method 500 includes monitoring a plurality of door sensors on doors providing access to the components of the printer. At 508, method 500 includes monitoring a plurality of temperature sensors of a conditioner and a dryer of the printer. At 510, method 500 includes turning off the conditioner and the dryer in response to any one of detecting an anomaly in the sensed movement of the print media, sensing a current outside a predetermined range based on an operating state of each component, detecting an open door, or detecting a temperature outside a predetermined range based on an operating state of each of the conditioner and the dryer.

As illustrated in FIG. 7B, at 512 method 500 may further include operating a first watchdog timer for a first ASIC monitoring the plurality of door sensors. At 514, method 500 may further include operating a second watchdog timer for a second ASIC monitoring the plurality of temperature sensors of the conditioner and the dryer. At 516, method 500 may further include operating a third watchdog timer for a FPGA driving heating elements of the conditioner. At 518, method 500 may further include turning off the conditioner and the dryer in response to any one of the first watchdog timer, the second watchdog timer, or the third watchdog timer elapsing.

As illustrated in FIG. 7C, at 520 method 500 may further include sensing a current of a drive motor of the printer. At 522, method 500 may further include turning off the drive motor in response to sensing a drive motor current outside a predetermined range based on an operating state of the drive motor. In one example, the operating state of each component is based on a command signal to each component, print media density, ambient temperature and humidity, printing speed, and AC voltage level.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A conditioner comprising:
a pressure roller assembly;
a heating element to heat the pressure roller assembly;
a drive motor to rotate the pressure roller assembly;
a current sensor to sense a current of the heating element;
a plurality of print media sensors to sense the movement of print media through the conditioner; and
a controller to turn off the heating element in response to any one of detecting an anomaly in the sensed movement of the print media or detecting a sensed current outside a predetermined range.

2. The conditioner of claim 1, wherein the controller is to detect anomalies in the sensed movement of the print media within two seconds of an anomaly and turns off the heating element.

3. The conditioner of claim 1, further comprising:
a plurality of temperature sensors, each temperature sensor to sense a temperature of the heating element,
wherein the controller is to turn off the heating element in response to any one of detecting a sensed temperature outside a predetermined range based on an operating state of each of the heating element and the drive motor or detecting an anomaly between the plurality of temperature sensors.

4. The conditioner of claim 1, wherein the controller comprises a plurality of application specific integrated circuits (ASICs) and each ASIC comprises a watchdog timer, and the controller is to turn off the heating element and the drive motor in response to any one of the watchdog timers elapsing.

5. The conditioner of claim 1, further comprising:
a line node and a neutral node, wherein the heating element is electrically coupled between the line node and the neutral node;
a thermal fuse electrically coupled in series with the heating element that trips to turn off the heating element in response to a temperature of the heating element exceeding a predetermined temperature;
a first overcurrent fuse between the line node and the heating element that trips to turn off the heating element in response to a current to the heating element exceeding a predetermined current; and
a second overcurrent fuse between the heating element and the neutral node that trips to turn off the heating element in response to a current from the heating element exceeding the predetermined current.

6. The conditioner of claim 1, further comprising:
a plurality of door sensors on doors providing access to the pressure roller assembly, the heating element, and the drive motor,
wherein the controller is to turn off the heating element and the drive motor in response to detecting an open door.

7. A conditioner comprising:
a pressure roller assembly;
a heating element to heat the pressure roller assembly;
a drive motor to rotate the pressure roller assembly;
an AC inlet to receive AC power to power the heating element and the drive motor;
a current sensor to sense a current through the AC inlet; and
a controller to turn off the heating element in response to detecting a sensed current outside a predetermined range based on an operating state of each of the heating element and the drive motor.

8. The conditioner of claim 7, further comprising:
a plurality of temperature sensors, each temperature sensor to sense a temperature of the heating element,
wherein the controller is to turn off the heating element in response to any one of detecting a sensed temperature outside a predetermined range based on an operating state of each of the heating element and the drive motor or detecting an anomaly between the plurality of temperature sensors.

9. The conditioner of claim 7, wherein the controller comprises a plurality of application specific integrated circuits (ASICs) and each ASIC comprises a watchdog timer, and the controller is to turn off the heating element and the drive motor in response to any one of the watchdog timers elapsing.

10. The conditioner of claim 7, further comprising:
a line node and a neutral node, wherein the heating element is electrically coupled between the line node and the neutral node;
a thermal fuse electrically coupled in series with the heating element that trips to turn off the heating element in response to a temperature of the heating element exceeding a predetermined temperature;
a first overcurrent fuse between the line node and the heating element that trips to turn off the heating element in response to a current to the heating element exceeding a predetermined current; and
a second overcurrent fuse between the heating element and the neutral node that trips to turn off the heating element in response to a current from the heating element exceeding the predetermined current.

11. The conditioner of claim 7, further comprising:
a plurality of door sensors on doors providing access to the pressure roller assembly, the heating element, and the drive motor,
wherein the controller is to turn off the heating element and the drive motor in response to detecting an open door.

12. A method for operating a printer, the method comprising:
monitoring a plurality of print media sensors to sense the movement of print media through a printer;
sensing a current through an AC inlet providing power to components of the printer;
monitoring a plurality of door sensors on doors providing access to the components of the printer;
monitoring a plurality of temperature sensors of a conditioner and a dryer of the printer; and
turning off the conditioner and the dryer in response to any one of detecting an anomaly in the sensed movement of the print media, sensing a current outside a predetermined range based on an operating state of each component, detecting an open door, or detecting a temperature outside a predetermined range based on an operating state of each of the conditioner and the dryer.

13. The method of claim 12, further comprising:
operating a first watchdog timer for a first application specific integrated circuit (ASIC) monitoring the plurality of door sensors;
operating a second watchdog timer for a second ASIC monitoring the plurality of temperature sensors of the conditioner and the dryer;
operating a third watchdog timer for a field programmable gate array (FPGA) driving heating elements of the conditioner; and
turning off the conditioner and the dryer in response to any one of the first watchdog timer, the second watchdog timer, or the third watchdog timer elapsing.

14. The method of claim 12, further comprising:
sensing a current of a drive motor of the printer; and
turning off the drive motor in response to sensing a drive motor current outside a predetermined range based on an operating state of the drive motor.

15. The method of claim 12, wherein the operating state of each component is based on a command signal to each component, print media density, ambient temperature and humidity, printing speed, and AC voltage level.
